(19) United States
(12) Patent Application Publication
(10) Pub. No.: US 2015/0039377 A1
(43) Pub. Date: Feb. 5, 2015

(54) INFORMATION OUTPUT APPARATUS, INFORMATION OUTPUT SYSTEM, AND INFORMATION OUTPUT METHOD

(71) Applicant: Ryoichi BABA, Tokyo (JP)

(72) Inventor: Ryoichi BABA, Tokyo (JP)

(73) Assignee: RICOH COMPANY, LTD., Tokyo (JP)

(21) Appl. No.: 14/303,721

(22) Filed: Jun. 13, 2014

(30) Foreign Application Priority Data
Jul. 30, 2013 (JP) 2013-157299

(51) Int. Cl. G06Q 10/06

(52) U.S. Cl. CPC G06Q 10/06315
USPC 705/7.25

(57) ABSTRACT

An information output apparatus includes a replacement information storage part storing first information and second information for each of replacements of a plurality of devices. The first information and the second information are associated with each other. The first information indicates a use condition of each of the devices before replacement. The second information indicates each of the devices after replacement. A use condition storage part stores third information indicating a use condition of each device. A selection part selects one of the replacements for which information is stored in the replacement information storage part based on the third information stored in the use condition storage part with respect to the one of the devices for which replacement is requested. The output part outputs the second information that indicates one of the devices after replacement and is stored in the replacement information storage part with respect to the selected replacement.

### CROSS-REFERENCE TO RELATED APPLICATION

The present application is based upon and claims the benefit of priority of Japanese Patent Application No. 2013-157299, filed on Jul. 30, 2013, the entire contents of which are incorporated herein by reference.

### BACKGROUND OF THE INVENTION

1. Field of the Invention

The present invention generally relates to an information output apparatus, an information output system and an information output method.

2. Description of the Related Art

Generally, an apparatus used in an office, such as an image forming apparatus installed in an office, is periodically replaced by a new apparatus. By replacing with a new apparatus, a user can expect an improvement in the quality of resulting products output by the apparatus. For example, if a new image forming apparatus is used, an improvement in the quality of results of printing can be expected. Additionally, an improvement in an operational efficiency is expected.

Japanese Laid-Open Patent Application No. 2008-165602 discloses a background art as described above.

### SUMMARY OF THE INVENTION

There is provided according to an aspect of the present invention an information output apparatus including: a replacement information storage part that stores first information and second information for each of replacements of a plurality of devices in a state where the first information and the second information are associated with each other, the first information indicating the use condition of each of the devices before replacement and the second information indicating each of the devices after replacement; a use condition storage part that stores third information indicating the use condition of each of the devices, the third information being received through a network; and a processor serving as a selection part and an output part, wherein the selection part selects, upon a request for replacement of one of the devices, one of the replacements for which information is stored in the replacement information storage part based on the third information stored in the use condition storage part with respect to the one of the devices for which replacement is requested, and the output part outputs the second information that indicates one of the devices after replacement and is stored in the replacement information storage part with respect to the selected replacement.

There is provided according to another aspect of the present invention an information output system including one or more computers, including: a replacement information storage part that stores first information and second information for each replacement of a plurality of devices in a state where the first information and the second information are associated with each other, the first information indicating use condition of each of the devices before replacement and the second information indicating each of the devices after replacement; a use condition storage part that stores third information indicating a use condition of each of the devices, the third information being received through a network; and a processor serving as a selection part and an output part, wherein the selection part selects, upon a request for replacement of one of the devices, one of the replacements for which information is stored in the replacement information storage part based on the third information stored in the use condition storage part with respect to the one of the devices for which replacement is requested, and the output part outputs the second information that indicates one of the devices after replacement and is stored in the replacement information storage part with respect to the selected replacement.

There is provided according to a further aspect of the present invention an information output method performed by an information output system including one or more computers, the information output system further including: a replacement information storage part that stores first information and second information for each of replacements of a plurality of devices in a state where the first information and the second information are associated with each other, the first information indicating use condition of each of the devices before replacement and the second information indicating each of the devices after replacement; and a use condition storage part that stores third information indicating a use condition of each of the devices, the third information being received through a network, the information output method including: selecting, upon a request for replacement of one of the devices, one of the replacements for which information is stored in the replacement information storage part based on the third information stored in the use condition storage part with respect to the one of the devices for which replacement is requested; and outputting the second information that indicates one of the devices after replacement and is stored in the replacement information storage part with respect to the selected replacement.

Other objects, features and advantages of the present invention will become more apparent from the following detailed description when read in conjunction with the accompanying drawings.

The objects and advantages of the invention will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

FIG. 1 is a diagram of a structure of a device management system according to an embodiment of the present invention;

FIG. 2 is a block diagram of an information management apparatus according to the embodiment of the present invention;

FIG. 3 is a functional block diagram of apparatuses according to the embodiment of the present invention;

FIG. 4 is a flowchart of a replacement report creating process;

FIG. 5 is an illustration of a display example of a report condition input screen;

FIG. 6 is an illustration indicating a structure of a device information accumulation part;

FIG. 7 is an illustration indicating a result of collecting use condition data of devices in a target site;

FIG. 8 is an illustration indicating a structure of a reference information storage part;

FIG. 9 is an illustration indicating examples of a matching degree;

FIG. 10 is an illustration indicating a matching degree regarding a device having a model name of MP400;

FIG. 11 is an illustration of a structure of a cost information storage part;

FIG. 12 is an illustration of a display example of a replacement report;

FIG. 13 is a flowchart of a reference information creating process;

FIG. 14 is an illustration indicating a structure of a replacement result storage part; and

FIG. 15 is an illustration indicating a result of collecting use conditions for the latest one month of a device before replacement.

### DETAILED DESCRIPTION OF THE PREFERRED EMBODIMENTS

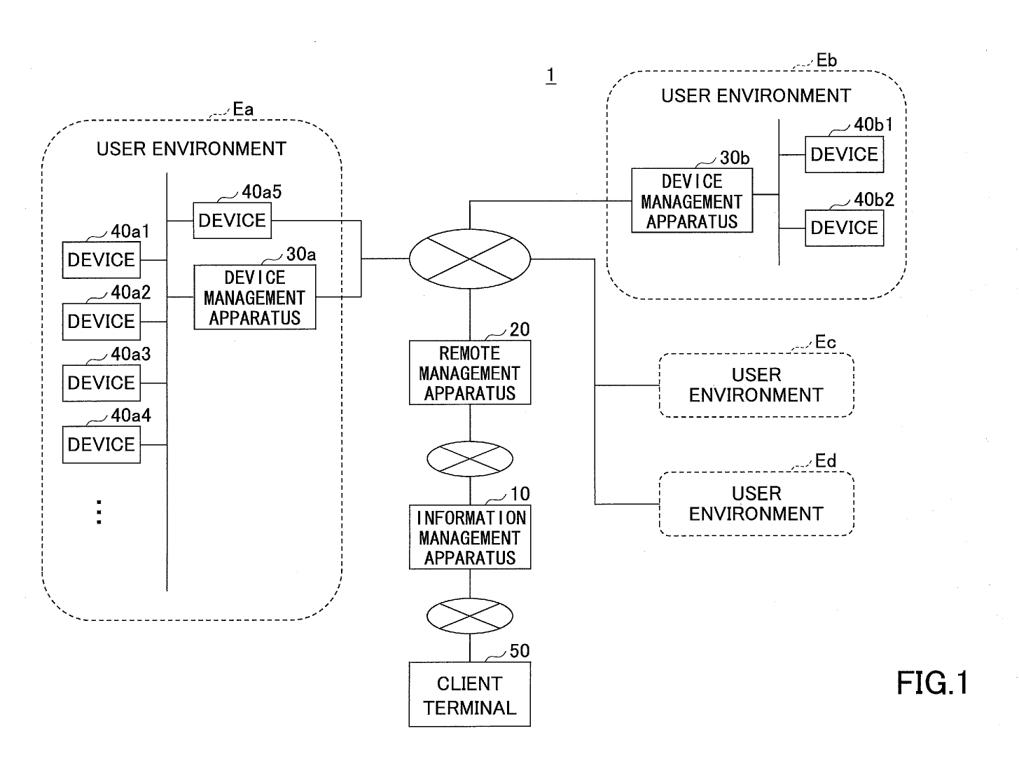

A description will now be given, with reference to the drawings, of an embodiment of the present invention. FIG. 1 is a diagram of a structure of a device management system according to an embodiment of the present invention. As illustrated in FIG. 1, the device management system 1 includes a plurality of user environments Ea to Ed (may be collectively referred to as user environments E), a remote management apparatus 20, an information management apparatus 10 and a client terminal 50.

Each of the user environments E is a system environment for a user (for example, a company user) of devices 40 (for example, devices 40a1 to 40a5 in the user environment Ea, and devices 40b1 and 40b2 in the user environment Eb). In the present embodiment, for the sake of convenience of explanation, the user environments E are assumed to be system environments of mutually different companies. However, a system corresponding to each of the user environments E is not limited to a company unit. A department or a section in one company may be associated with one of the user environments E.

Each of the environments E includes one or more devices 40 and a device management apparatus 30 (a device management apparatus 30a in the user environment Ea, and a device management apparatus 30b in the user environment Eb), if necessary. The devices 40 are, for example, image forming apparatuses such as multifunction peripherals or the like that send device information to the device management apparatus 30 or the remote management apparatus 20. That is, the devices 40 are target devices to be managed in the device management system 1.

Each of the device management apparatus 30 is a computer that collects device information from each of the devices 40 installed in the user environment to which the device management apparatus 30 concerned belongs. The device management apparatus 30 also uploads the collected device information to the remote management apparatus 20. That is, the device management apparatus 30 is connected to the devices 40 in the same user management E through a network such as a local area network (LAN) or a wide area network (WAN), and the device management apparatus 30 in each user environment E is connected to the remote management apparatus 20 through a network such as a wide area network (WAN). There may be devices 40, such as the device 40a5 in the user environment Ea that can directly communicate with the remote management apparatus 20 without going through the device management apparatus 30. The device information of the devices 40 may be uploaded to the remote management apparatus 20 without going through the device management apparatus 30. It should be noted that, in the present embodiment, the device information mainly indicates use conditions of the devices 40. However, the device information may include attribute information of the devices 40, information indicating status of the devices 40 or information of setting of the devices 40.

On the other hand, the remote management apparatus 20 and the information management apparatus 10 are operated by an organization taking charge of maintenance of the devices 40.

The remote management apparatus 20 is a computer that centrally receives the device information uploaded by the device management devices 30 or the devices 40 of the user environments E. It should be noted that the uploading of the device information is made at a time when, for example, a device structure is changed in the user environments E or the device information of one of the devices 40 is changed. Additionally, the upload of the device information may be made periodically or at other timings.

The information management apparatus 10 is a computer that manages the device information received by the remote management apparatus 20 and performs a predetermined process using the device information. In the present embodiment, the information management apparatus 10 performs a process for assisting a replacement of the devices 40 in the user environments E. The assistance of replacement mainly means assistance for selection of the devices 40 to replace.

The remote management apparatus 20 and the information management apparatus 10 are connected through a network such as LAN or WAN. However, the remote management apparatus 20 and the information management apparatus 10 may be realized by a single computer. Alternatively, each of the remote management apparatus 20 and the information management apparatus 10 may be a computer system configured by a plurality of computers.

The client terminal 50 is, for example, a terminal used by a maintenance worker of the devices 40 in the user environments E. The client terminal 50 serves as a user interface for the information management apparatus 10. The client terminal 50 may be a personal computer (PC), a smartphone, a tablet-type terminal, a cellular phone, etc.

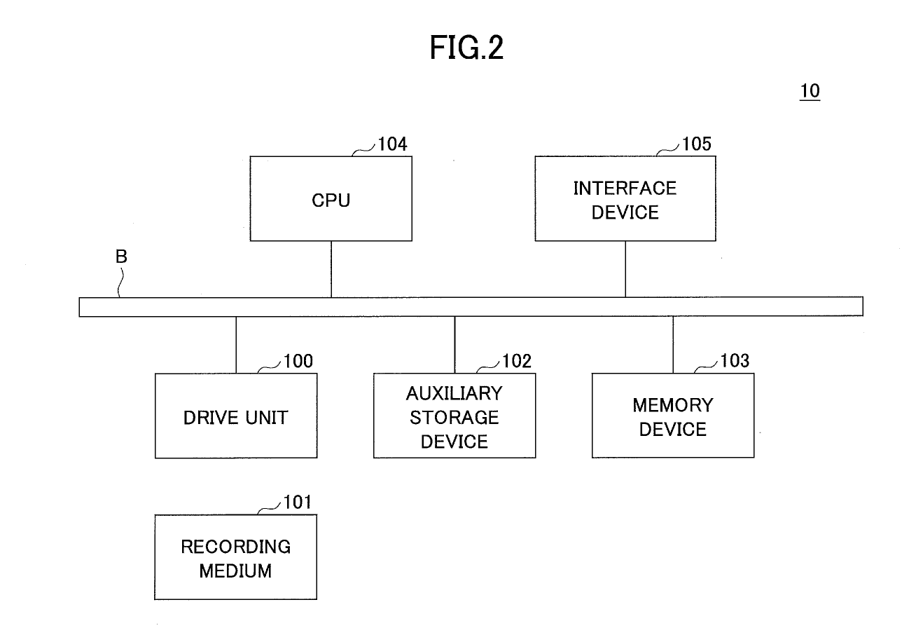

FIG. 2 is a block diagram of the hardware structure of the information management apparatus according to the present embodiment. As illustrated in FIG. 2, the information management apparatus 10 includes a drive unit 100, an auxiliary storage device 102, a memory device 103, a central processing unit (CPU) 104 and an interface device 105.

Programs that perform a process by the information management apparatus 10 are provided by a recording medium 101 such as a CD-ROM or the like. When the recording medium 100 storing programs is set in the drive unit 100, the programs are read from the recording medium 101 and installed in the auxiliary storage device 102. However, the programs are not necessarily read from the recording medium 101, and may be downloaded from other computers through a network. The auxiliary storage device 102 stores the installed programs, and also stores necessary files and data.

The memory device 103 reads programs from the auxiliary storage device 102 and stores the read programs therein. The CPU 104 performs functions of the information management apparatus 10 according to the programs stored in the memory device 103. The interface device 105 is used as an interface for connecting the information management apparatus 10 to the network.

It should be noted that the device management apparatus 30 and the remote management apparatus 20 may have the same hardware structure as the information management apparatus 10.

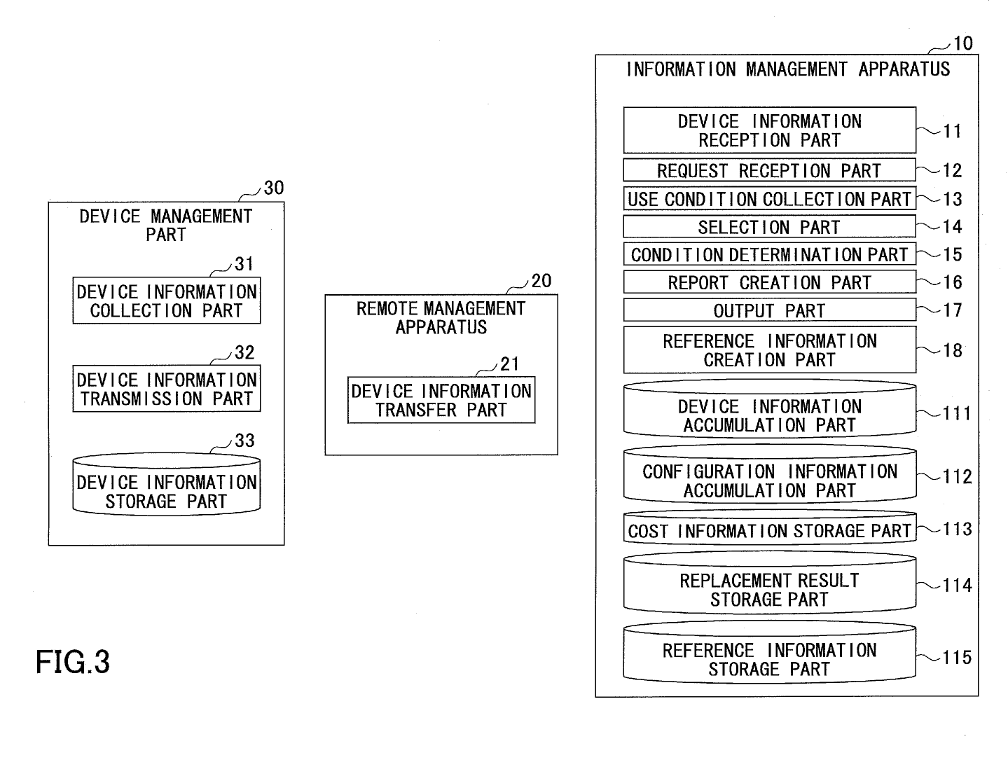

FIG. 3 is a functional block diagram of the apparatuses according to the present embodiment. As illustrated in FIG. 3, the device management apparatus 30 includes a device information collection part 31 and a device information transmission part 32. Each of the device information collection part 31 and the device information transmission part 32 is realized by the CPU of the device management apparatus 30 executing programs installed in the device information apparatus 30. The device management apparatus 30 also uses a device information storage part 33. The device information storage part 33 can be a storage device provided in the device management apparatus 30 or a storage device connected to the device management apparatus 30 through the network.

The device information collection part collects device information from each of the devices 40 that belong to the same user environment E as the device management apparatus 30 concerned. The device information collected by the device information collection part 32 is stored in the device information storage device 33. The device information transmission part 32 transmits (uploads) the device information stored in the device information storage part 33 to the remote management apparatus 20.

The remote management apparatus 20 includes a device information transfer part 21. The device information transfer part 21 can be, for example, the CPU of the remote management apparatus 20 executing programs installed in the remote management apparatus 20.

The device information transfer part 21 transfers the device information transmitted (uploaded) by the device management apparatus 30 to the information management apparatus 10.

The information management apparatus 10 includes a device information reception part 11, a request reception part 12, a use condition collection part 13, a selection part 14, a condition determination part 15, a report creation part 16, an output part 17 and a reference information creation part 18. Each of those parts is realized by the CPU 104 executing the programs installed in the information management apparatus 10. The information management apparatus 10 also uses a device information accumulation part 111, a configuration information storage part 112, a cost information storage part 113, a replacement result storage part 114 and a reference information storage part 115. Each of those storage parts is realized by the auxiliary storage device 102 or a storage device connected to the information management apparatus 10 through the network.

The device information reception part 11 receives the device information transferred by the remote management apparatus 20. The device information received by the device information reception part 11 is stored in the device information accumulation part 111. Accordingly, the device information of the devices 40 in the plurality of user environments E is accumulated in the device information accumulation part 111.

The request reception part 12 receives a request from the client terminal 50. For example, the request reception part 12 receives a request for creating a replacement report and information of a result of replacement being performed from the client terminal 50. The replacement report includes suggestion information indicating a recommended mode with respect to replacement of the devices 40.

The use condition collection part 13 collects use conditions in the user environment E that is a target of creating a replacement report using the device information accumulated in the device information accumulation part 111 in response to the request for creating a replacement report.

The selection part 14 selects or extracts a piece of reference information from among pieces of reference information stored in the reference information storage part 115 based on the result of collection by the use condition collection part 13. The reference information is information with which information indicating use condition of the device 40 before replacement, information indicating the device 40 before replacement and information indicating use condition of the device 40 after replacement are associated for each of the user environments E in which a replacement of the device 40 was performed. The reference information is referred to when a new replacement is performed.

The condition determination part 15 determines whether a replacement of the device 40 based on a piece of reference information selected by the selection part 14 satisfies a predetermined condition with respect to the user environment, which is a target for creating a replacement report.

The report creation part 16 creates a replacement report based on a piece of reference information which is determined to satisfy the predetermined condition by the condition determination part 15. The output part 17 outputs the replacement report created by the report creation part 16. The reference information creation part 18 creates the reference information based on the information stored in the replacement result storage part 114 and the device information stored in the device information accumulation part 111. The created reference information is stored in the reference information storage part 115.

The replacement result storage part 114 stores information indicating the contents of replacement for each replacement result. The configuration information storage part 112 stores information indicating a configuration of each device (information indicating a model of each device 40 and the number of devices 40 installed).

The cost information storage device 113 stores parameters for calculating a maintenance cost of each device 40 for each model of the devices 40.

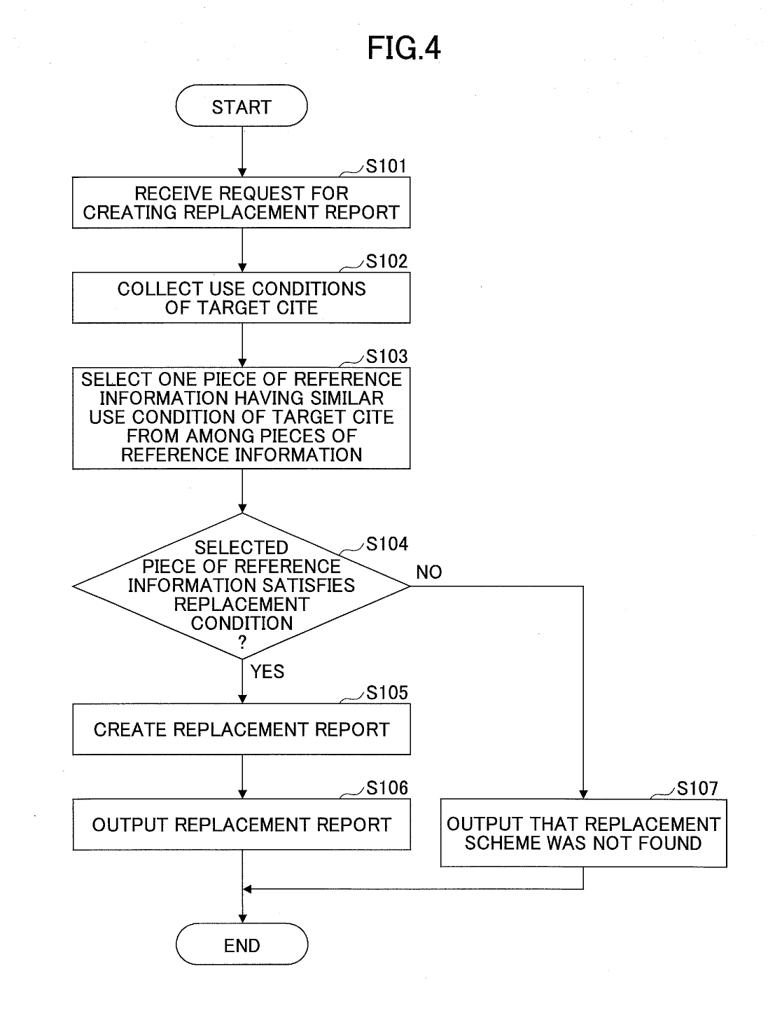

A description is given below of a process of creating a replacement report performed by the information management apparatus 10. FIG. 4 is a flow chart of the process of creating a replacement report.

The request reception part 12 receives, in step S101, a request for creating a replacement report from the client terminal 50. In the request for creating a replacement report, for example, a report condition input by a maintenance worker using a report condition input screen displayed in the client terminal 50 is designated.

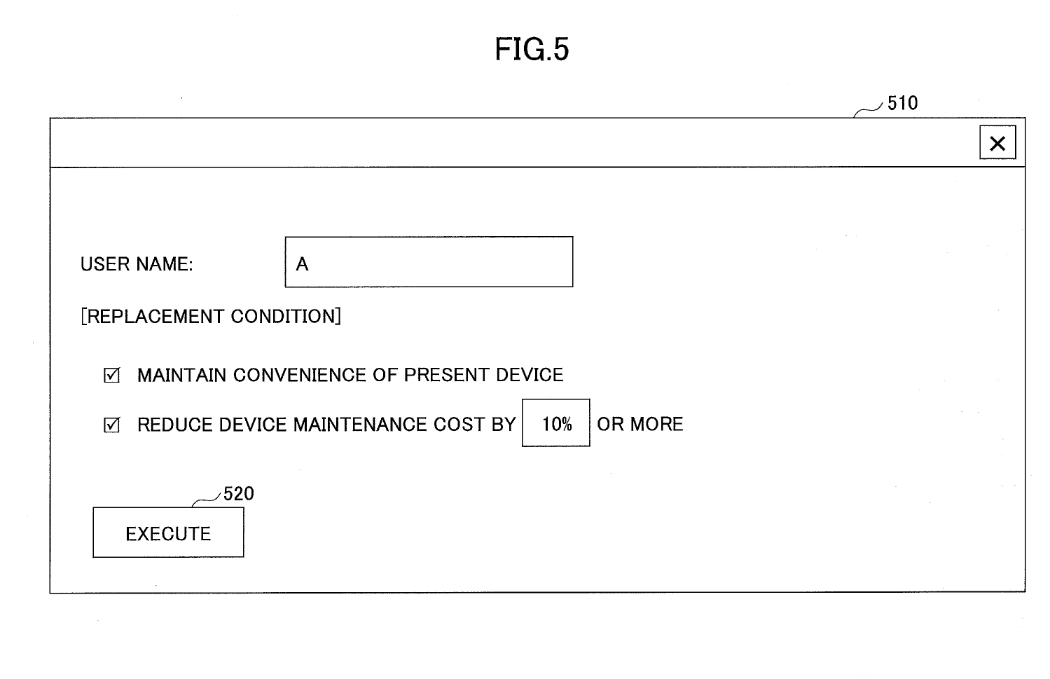

FIG. 5 is an illustration of a display example of a report condition input screen. A user can input a user name and a replacement condition through a report condition input screen 510 illustrated in FIG. 5. The user name is discrimination information to discriminate each of the user environments E (for example, for each client). The replacement condition is a condition with respect to replacement of the devices 40. In the example illustrated in FIG. 5, “maintain convenience of present device” (hereinafter, referred to as “condition 1”) and “reduce device maintenance cost by N or more” (hereinafter, referred to as “condition 2”) are set as candidates of elements which constitute the replacement condition. In the example illustrated in FIG. 5, satisfaction of both the condition 1 and condition 2 is designated as the replacement condition. The replacement condition may be replaced appropriately by a different condition, or a new condition may be added. It should be noted that the report condition is a concept containing the user name and the replacement condition.

When the selection of the user name and the replacement condition is made, and an execution button 520 is pressed, the client terminal 50 sends a request for creating the replacement report in which the report condition is designated to the information management apparatus 10. Then, the request for creating the replacement report is received, in step S101, by the request reception part 12 of the information management apparatus 10.

Then, the use condition collection part 13 of the information management apparatus 10 collects, in step S102, a use condition of the device 40, which is before being replaced, that is, which is presently used, in the user environment E (hereinafter, referred to as “target site”) relating to the user name contained in the report condition designated in the request for creating the replacement report. It should be noted that the all devices 40 in the target site are assumed to be targets to be replaced in the present embodiment for the sake of convenience. However, a portion of the devices in the target site may be set as targets to be replaced. In such as case, information indicating the part of the devices 40 is designated in the report condition.

The collection of the use condition of the device 40 is performed using the device information stored in the device information accumulation part 111.

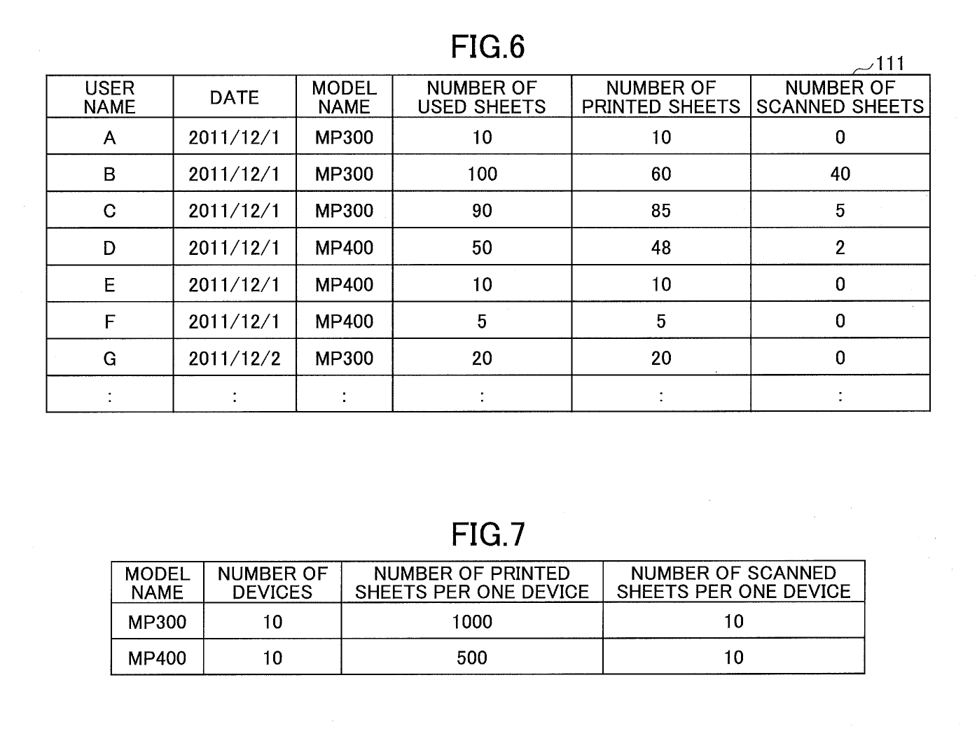

FIG. 6 is an illustration of a structure of the device information accumulation part 111. The device information accumulation part 111 stores a history of device information received by the device in formation reception part 11 of the information management apparatus 10. As illustrated in FIG. 6, the device information contains a user name, date, a model name, a number of used sheets, a number of printed sheets and a number of scanned sheets.

The user name is a name of the user with respect to the user environment E in which the device management apparatus 30, which is a sender of the device information. The date is a date when the device information is stored in the device information accumulation part 111. The model name is a name of identifying a model of the device 40 used in the user environment E with respect to the user name.

The number of used sheets and the number of scanned sheets are examples of information indicating the use condition of the device 40. That is, the number of used sheets is a total of sheets to which printing or scanning is performed for one day. That is, in the present embodiment, the device information is updated at a fixed time every day from the device management apparatus 30 of each of the user environments E. The number of scanned sheet is a number of sheets to which scanning was performed. Here, scanning means a process of storing image data in a file. Accordingly, in the case of scanning, toner or ink is not consumed.

It is assumed that one record illustrated in FIG. 6 is a result of collection of the device information of the devices 40 which model name is common in one of the user environments E. Accordingly, for example, the number of used sheets, the number of printed sheets and the number of scanned sheets in the record for user name “A” of model number “MP300” are a total number of sheets used, a total number of sheets printed, and a total number of sheets scanned for one day by each of the devices 40 belonging to the user environment E for user name is “A” and the model name thereof is “MP300”.

The use condition collection part 13 extracts, in step S102, from the device information accumulation part 111 a record containing the user name of the target site, which date is contained in the latest one month. The use condition collection part 13 collects the number of printed sheets and the number of scanned sheets in the extracted records by a unit having a common model name, and converts the results of the collection into a value per one device. That is, the result of collection with respect to each model is divided by a number of devices 40 having the model name concerned. The number of devices 40 installed in each of the user environments E is previously stored in the configuration information accumulation part 112. It should be noted that records whose date is contained in the last N months (N>1) may be extracted from the device information accumulation part 111, and an average value for one month in the N months may be calculated as the result of collection. That is, the result of collection may not be a value of the latest one month.

FIG. 7 is an illustration indicating an example of a result of collection of the use condition of the devices 40 belonging to a target site. The result of collection of the use condition illustrated in FIG. 7 includes a model number, a number of devices, a number of printed sheets per one device and a number of scanned sheets per one device. It should be noted that the number of printed sheets and the number of scanned sheets are for one month.

Then, the selection part 14 of the information management apparatus 10 selects a piece of reference information, which is to be a reference of a replacement report at this time, from the pieces of reference information stored in the reference information storage part 115 based on the result of collection of use condition of the devices 40 in the target site.

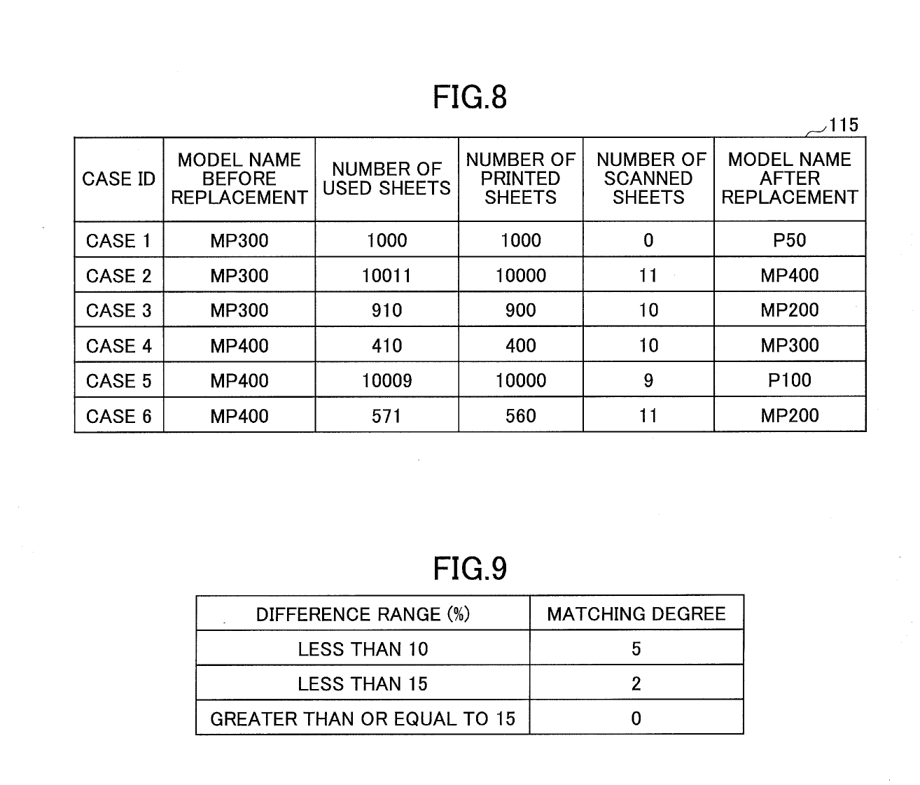

FIG. 8 is an illustration of a structure of the reference information storage part 115. The reference information storage part 115 stores reference information with respect to a result of replacement (hereinafter, referred to as “replacement case”) of the devices 40 in the past in any one of the user environments E. The reference information contains a case ID, a model name before replacement, a number of used sheets, a number of printed sheets, a number of scanned sheets and a model number after replacement.

The case ID is identification information for each result of replacement (replacement case). In each replacement case, it is assumed that replacement was made with respect to all devices in the user environment associated with the replacement case concerned. Accordingly, a number of replaced devices is omitted because a number of replaced devices can be specified based on the information stored in the configuration information storage part 112. If the target to be replaced is not all devices 40, the number of replaced devices may be contained in each piece of reference information. The model name before replacement is a model name of each of the devices 40. The number of used sheets, the number of printed sheets and the number of scanned sheets are an average value of the used sheets, an average value of the printed sheets and an average value of the scanned sheets, respectively, of one device before replacement for one month. That is, the number of used sheets, the number of printed sheets and the number of scanned sheets are examples of information indicating a use condition before replacement. The model name after replacement is a model name of each device 40 after replacement. Although an example in which the devices 40 have a common model name is indicated for each of all devices 40 before replacement and all devices 40 after replacement in the present embodiment, the model name of all devices 40 before replacement is not necessarily common. Additionally, the model name of all devices 40 after replacement is not necessarily common.

In step S103, a piece of reference information is selected from the pieces of information stored in the reference information storage device 115, the piece of information containing a model name matching the model name of the devices 40 in the target site and information indicating a use condition (that is, a number of printed sheets and a number of scanned sheets) being similar to the result of collection of the used condition of the devices in the target site (FIG. 7).

As illustrated in FIG. 7, in the present embodiment, the devices 40 set as a target device to be replaced in the target site are devices having the model name “MP300” and devices having the model name of “MP400”. The model name “MP300” matches the model name before replacement of the cases 1, 2 and 3 in the pieces of reference information illustrated in FIG. 8. Thus, it is determined as to which case has information indicating the use condition being most similar to the result of collection of use condition of the devices 40 in the target site.

In the present embodiment, the similarity of information indicating use condition is determined based on an index value referred to as “matching degree” which is a value indicating a degree of matching of a comparison target. The matching degree is a value assigned in response to a percentage of a difference of values compared for each parameter configuring the information indicating use condition.

FIG. 9 is an illustration indicating examples of the matching degree. In the example illustrated in FIG. 9, the difference range is divided into three ranges, a range of less than 10%, a range of less than 15%, and a range of greater than or equal to 15%, and values 5, 2, and 0 as matching degrees are assigned to the three ranges, respectively. A method of dividing the difference range and a value of the matching degree given to each divided range may be appropriately changed. A relationship between the difference range and the matching degree may be defined in a program logic, which lets the CPU 104 to serve as the selection part 14, or may be stored in the auxiliary device 102 as external information of the program concerned.

With respect to the devices 40 having model name “MP300”, in the use condition in the target site, the number of printed sheets is 1000, the number of scanned sheets is 10. In the use condition in case 1, the number of printed sheets is 100 and the number of scanned sheets is 0, as illustrated in FIG. 8. Accordingly, a percentage of difference in the number of printed sheets and a percentage of difference in the number of scanned sheets are calculated as follows.

A percentage of difference of the number of printed sheets=(1000−1000)÷1000×100=0%

A percentage of difference of the number of scanned sheets=(10−0)÷10×100=100%

Accordingly, it is appreciated from FIG. 9 that the matching degree of the number of printed sheets for case 1 is 5, and the matching degree of the number of printed sheets for case 1 is 0.

In the use condition in case 2, the number of printed sheets is 10000 and the number of scanned sheets is 11, as illustrated in FIG. 8. Accordingly, a percentage of difference in the number of printed sheets and a percentage of difference in the number of scanned sheets are calculated as follows.

A percentage of difference of the number of printed sheets=(1000−10000)÷1000×100=−900%

A percentage of difference of the number of scanned sheets=(10−11)÷10×100=−10%

Accordingly, it is appreciated from FIG. 9 that the matching degree of the number of printed sheets for case 2 is 0, and the matching degree of the number of printed sheets for case 2 is 2.

In the use condition in case 3, the number of printed sheets is 900 and the number of scanned sheets is 2, as illustrated in FIG. 8. Accordingly, a percentage of difference in the number of printed sheets and a percentage of difference in the number of scanned sheets are calculated as follows.

A percentage of difference of the number of printed sheets=(1000−900)÷1000×100=10%

A percentage of difference of the number of scanned sheets=(10−10)÷10×100=0%

Accordingly, it is appreciated from FIG. 9 that the matching degree of the number of printed sheets for case 3 is 2, and the matching degree of the number of printed sheets for case 3 is 5.

The total of the matching degree of the number of printed sheets and the matching degree of the number of scanned sheets is 5 in case 1, 2 in case 2 and 7 in case 3. Because a similarity is higher as the total of the matching degree is larger, the reference information with respect to case 3 is selected.

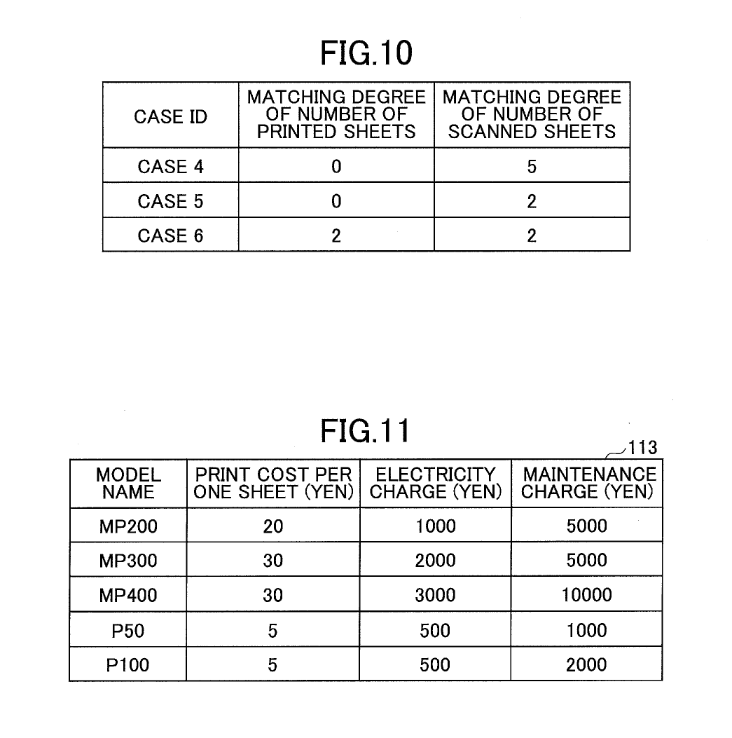

By performing the same operations with respect to the devices 40 having the model name “MP400”, the matching degrees for cases 4 to 6 are obtained as illustrated in FIG. 10. As appreciated from FIG. 10, a total of the matching degrees is at a maximum in case 4. Accordingly, the reference information of case 4 is selected.

It should be noted that the matching of the model name may be excluded from the selection condition of the reference information. With respect to the selection of the reference information, similarity of use condition of the devices 40 may be given a priority. In such a case, narrowing down according to the model name is not performed, and the reference information may be selected based on the matching degree of the information indicating use condition.

Consequently, the condition determination part 15 determines, in step S104, whether the selected reference information satisfies the replacement condition. First, with respect to condition 1 “maintaining convenience of the present device”, it is considered that the replacement condition is satisfied because the reference information is selected based on the matching degree. This is because it is considered that the similarity in the use condition indicates that a possibility of maintaining the convenience is high. However, satisfaction of condition 1 may be determined according to whether commonality in functions between the model name after replacement in the selected reference information and the device 40 of the target for replacement in the target site is high. In such as case, information indicating the function of the model concerned may be stored in, for example, the auxiliary storage device 102.

With respect to condition 2 “reduce maintenance cost by N or more”, satisfaction is determined by calculating the present maintenance cost and the maintenance cost when a replacement is performed based on the reference information and comparing both the calculated maintenance costs.

In the present embodiment, the maintenance cost of the device 40 for one month is calculated by the following formula (1):

maintenance cost of the device 40 for one month=a number of devices 40×(a number of printed sheets for one month×print cost per one sheet+electric charge per one device for one month+maintenance charge per one device for one month) (1)

Here, reference values or standard values of the print cost per one sheet, the electric charge per one device for one month and the maintenance charge per one device for one month are stored in the cost information storage part 113.

FIG. 11 is an illustration of a structure of the cost information storage part 113. As illustrated in FIG. 11, the cost information storage part 113 stores the print cost per one sheet, the electric charge per one device for one month and the maintenance charge per one device for one month by being associated with each model name. The electric charge may be calculated based on the power consumption per one device for one month.

The calculation of the maintenance cost of the present device 40 with respect to a target site based on FIG. 11 and FIG. 7 is described in the following.

10×(30×1000+2000+5000)+10×(30×500+3000+10000)=370000+280000=650000 (yen)

It should be noted that 370000 (yen) is a maintenance cost with respect to MP300, and 280000 (yen) is a maintenance cost with respect to MP400. Because scanning does not require a printing cost, the number of scanned sheets does not contribute to the maintenance cost.

On the other hand, according to the reference information of the selected case 3, MP300 should be replaced by MP200. Additionally, according to the reference information of the selected case 4, MP400 should be replaced by MP300. On the assumption that those replacements are made, the maintenance cost is calculated as follows based on the formula (1).

10×(20×1000+1000+5000)+10×(30×500+2000+5000)=260000+220000=480000 (yen)

It should be noted that 260000 (yen) is a maintenance cost with respect to MP200, and 220000 (yen) is a maintenance cost with respect to MP300.

Accordingly, the rate of reduction of the maintenance cost due to the replacements according to the reference information of cases 3 and 4 is as follows.

(650000−480000)÷650000×100≈26.2(%)

Accordingly, the condition 2 is satisfied.

If it is determined that both condition 1 and condition 2 are satisfied (Yes, of S104), the report creation part 16 creates, in step S105, a replacement report according to the reference information of the cases 3 and 4. Then, the output part 17 outputs, in step S106, the replacement report created by the report creation part 16. As an example of the output form, there is a transmission of the replacement report to the client terminal 50. For example, the client terminal 50 causes the received replacement report to be displayed.

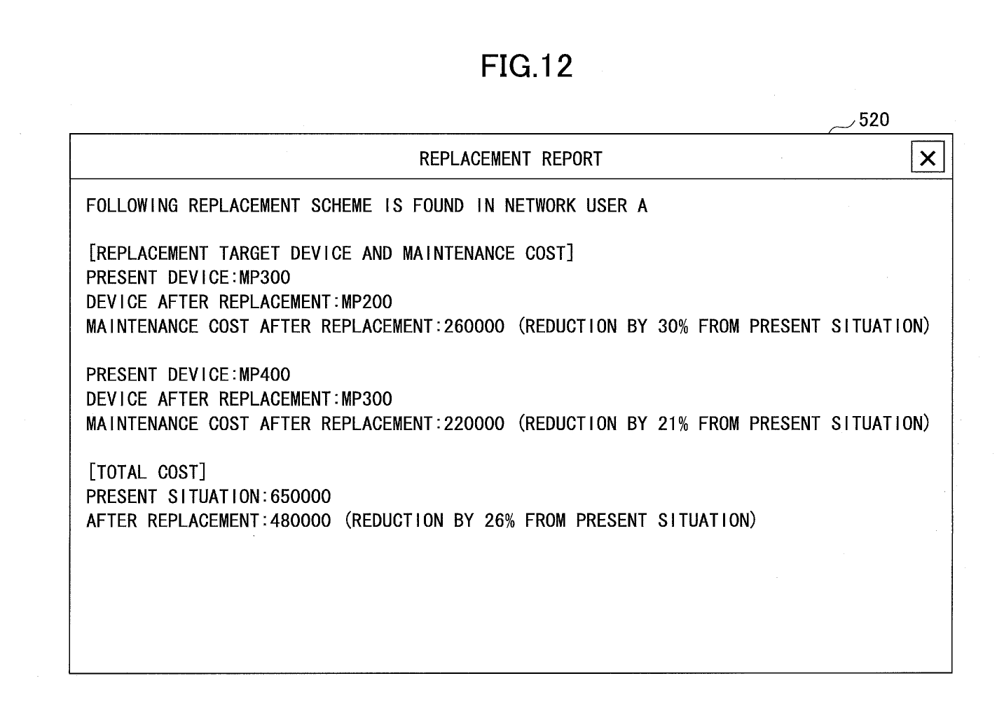

FIG. 12 is an illustration of display of the replacement report. In FIG. 12, the replacement report is displayed in a screen 520 displayed on the client terminal 50. In the replacement report illustrated in FIG. 12, a suggestion is made to replace the device 40 of model name “MP300” by a device of model name “MP200” and the maintenance cost of the case where the replacement concerned is made is indicated. Additionally, a suggestion is made to replace the device 40 of model name “MP400” by a device of model name “MP300” and the maintenance cost of the case where the replacement concerned is made is indicated. Further, the total cost of the present situation and the total cost after the replacements are displayed.

A user (maintenance personnel) can create a suggestion of replacement of the device 40 in the user environment E by referring to such a replacement report. The output form of the replacement report is not limited to the display on the client terminal 50. For example, the output form may be a transmission to a predetermined mail address, or an output to a predetermined printer.

On the other hand, if it is determined that at least one of condition 1 and condition 2 is not satisfied (No of S104), the output part 17 returns, in step S107, to the client terminal 50 information indicating that a suggestion of replacement is not found.

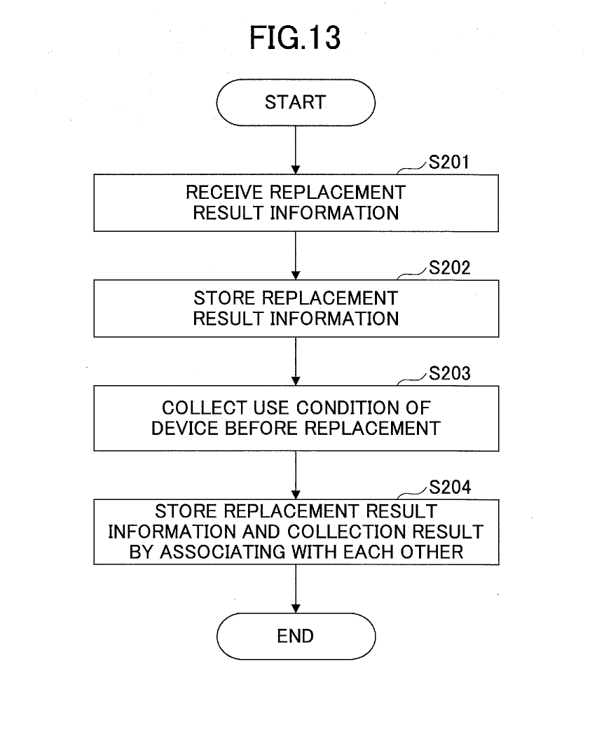

A description is given below of a creation process of the reference information stored in the reference information storage part 115. FIG. 13 is a flowchart of a creation process of the reference information.

For example, when a replacement of the device 40 is done in a user environment E, the request reception part 12 of the information management apparatus 10 receives, in step S201, an input of information regarding the replacement concerned (hereinafter, referred to as “replacement result information”). The replacement result information may be input at, for example, the client terminal 50 and may be transmitted from the client terminal 50 to the information management apparatus 10. Then, the request reception part 12 stores, in step S202, the replacement result information to the replacement result storage part 114.

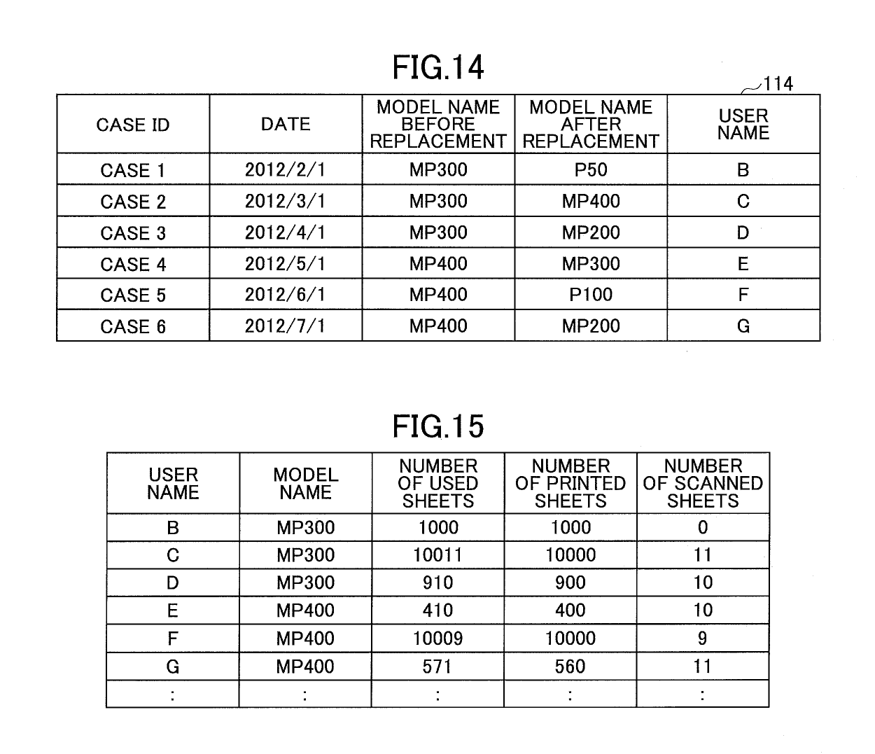

FIG. 14 is an illustration of a structure of the replacement result storage part 114. As illustrated in FIG. 14, the replacement result storage part 114 stores a case ID, date, model name before replacement, model name after replacement and user name for each result of replacement. The case ID is identification information for each replacement result (replacement case). The case ID is assigned to each replacement information when the replacement information is stored in the replacement result storage part 114. The date is a date of a replacement being done. The model name before replacement is a model name of each device 40 before being replaced. The model name after replacement is a model name of each device 40 after being replaced (a device that replaces). The user name is identification information of the user environment E in which the replacement was done.

In step 202, a new record is created in the replacement result storage part 114, and the replacement information received in step S201 is stored in the record concerned.

Then, the reference information creation part 18 collects, in step S203, use conditions of the device 40 before replacement for one month. The collection may be calculated in the same manner as the result of collection illustrated in FIG. 7 using the device information accumulation part 111.

FIG. 15 is an illustration of a result of collection of use conditions of the device 40 before replacement for the latest one month. FIG. 15 indicates a model name, a number used sheets per one device for one month, a number of printed sheets per one device for one month and a number of scanned sheets per one device for one month for each user name.

Although the collection result is illustrated with respect to a plurality of user names in FIG. 15, what is required in step S203 is to collect the used conditions with respect to the replacement at this time.

Then, the reference information creation part 18 stores, in step 204, the placement result information with respect to the replacement at this time and the collection result of user conditions with respect to the user name concerned in the reference information storage part 115 (FIG. 8) by associating them with each other. That is, the case ID, the model name before replacement, and the model name after replacement are extracted from the replacement result information (FIG. 14), and the number of printed sheets and the number of used sheets are extracted from the collection result of user conditions (FIG. 15). The items of extracted information are associated with each other and stored in the reference information storage part 115

As mentioned above, according to the present embodiment, the replacement report (suggestion or scheme of replacement) can be created by referring to a replacement result in which a use condition of the device 40 is similar to the user environment E of the suggested replacement from among results of replacement that have been done in any one of the user environments E in the past. That is, the replacement suggestion or scheme backed up by results can be created. As a result, a replacement suggestion or scheme appropriate for the user environment E to which the replacement suggestion or scheme is made can be presented. Thus, assistance of the replacement of the device 40 can be made.

It should be noted that the information management apparatus 10 in the present embodiment is an example of the information output apparatus and the information output system. The request for creating a replacement report is an example of a request of replacement of a device. The reference information storage part 115 is an example of a replacement information storage part. The device information accumulation part 111 is an example of a use condition storage part. The reference information creation part 18 is an example of the replacement information creation part. The maintenance cost of the device 40 is an example of a first cost and a second cost.

The present invention can be implemented in any convenient form, for example, using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitable programmed apparatuses such as a general purpose computer, personal digital assistant (PDA), mobile telephone (such as a WAP or 3G-compliant phone) and so on. Since the present invention can be implemented as software, each and every aspect of the present invention thus encompasses computer software implementable on a programmable device. The computer software can be provided to the programmable device using any conventional carrier medium. The carrier medium can compromise a transient carrier medium such as an electrical, optical, microwave, acoustic or radio frequency signal carrying the computer code. An example of such a transient medium is a TCP/IP signal carrying computer code over an IP network, such as the Internet. The carrier medium can also comprise a storage medium for storing processor readable code such as flexible magnetic disk, hard disc, CD-ROM, magnetic tape device or solid state memory device. The computer software can be provided to the programmable apparatus using any non-transient recording medium for recording processor readable code, such as a flexible magnetic disk, hard disk, CD-ROM, magnetic tape, solid-state memory, etc. The hardware platform encompasses any suitable hardware resources including, for example, a central processing unit (CPU), random access memory (RAM), hard disc drive (HDD), etc. The CPU can be configured by any suitable types and numbers of processors. The RAM can be configured by any suitable volatile or non-volatile memory. The HDD can be configured by any suitable non-volatile memory that can record a large amount of data. The hardware resources may further be equipped with an input device, output device or network device in conformity with the device type. The HDD may be provided outside the apparatus as long as it can be accessed. In such an example, the CPU and RAM like a cache memory of CPU can serve as a physical memory or main memory of the apparatus, whereas the HDD can serve as a secondary memory of the apparatus.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. An information output apparatus comprising:
a replacement information storage part that stores first information and second information for each of replacements of a plurality of devices in a state where the first information and the second information are associated with each other, the first information indicating use condition of each of the devices before replacement and the second information indicating each of the devices after replacement;
a use condition storage part that stores third information indicating a use condition of each of the devices, the third information being received through a network; and
a processor serving as a selection part and an output part,
wherein said selection part selects, upon a request of replacement of one of the devices, one of the replacements of which information is stored in said replacement information storage part based on the third information stored in said use condition storage part with respect to the one of the devices of which replacement is requested, and
said output part outputs the second information that indicates one of the devices after replacement and is stored in said replacement information storage part with respect to the selected replacement.

2. The information output apparatus as claimed in claim 1, wherein said processor also serves as a replacement information creation part that stores the third information and the second information in said replacement information storage part in a state where the third information is associated with the second information, the third information having been stored in said use condition storage part and relating to information, which is input in accordance with a replacement of the one of the devices, indicating the one of the devices before replacement, the second information being input in accordance with the replacement of the one of the devices.

3. The information output apparatus as claimed in claim 1, wherein said selection part calculates a value indicating a degree of matching of the third information stored in said use condition storage part with respect to one of the devices to which said request of replacement is made and the first information stored in said replacement information storage part and indicating use condition of each of the devices, said selection part selecting one of the replacements based on the calculated value.

4. The information output apparatus as claimed in claim 1, wherein said selection part calculates a first cost and a second cost, the first cost being calculated based on the third information stored in said use condition storage part and with respect to the one of the devices to which said request of replacement is made, the second cost being calculated based on the use condition with respect to one of the devices after replacement that is indicated in the selected replacement; and
said output part outputs, in a case where said first cost and said second cost satisfy a predetermined condition, the second information that indicates the one of the devices after replacement and is stored in said replacement information storage part with respect to the selected replacement.

5. The information output apparatus as claimed in claim 4, wherein said output part further outputs information indicating said first cost and information indicating said second cost.

6. An information output system including one or more computers, comprising:
a replacement information storage part that stores first information and second information for each of replacements of a plurality of devices in a state where the first information and the second information are associated with each other, the first information indicating use condition of each of the devices before replacement and the second information indicating each of the devices after replacement;
a use condition storage part that stores third information indicating a use condition of each of the devices, the third information being received through a network; and
a processor serving as a selection part and an output part,
wherein said selection part selects, upon a request of replacement of one of the devices, one of the replacements of which information is stored in said replacement information storage part based on the third information stored in said use condition storage part with respect to the one of the devices of which replacement is requested, and
said output part outputs the second information that indicates one of the devices after replacement and is stored in said replacement information storage part with respect to the selected replacement.

7. An information output method performed by an information output system including one or more computers, the information output system further including:
a replacement information storage part that stores first information and second information for each of replacements of a plurality of devices in a state where the first information and the second information are in associated with each other, the first information indicating use condition of each of the devices before replacement and the second information indicating each of the devices after replacement; and
a use condition storage part that stores third information indicating a use condition of each of the devices, the third information being received through a network,
the information output method comprising:
selecting, upon a request of replacement of one of the devices, one of the replacements of which information is stored in said replacement information storage part based on the third information stored in said use condition storage part with respect to the one of the devices of which replacement is requested; and
outputting the second information that indicates one of the devices after replacement and is stored in said replacement information storage part with respect to the selected replacement.
